(19) United States
(12) Patent Application Publication
(10) Pub. No.: US 2017/0212450 A1
(43) Pub. Date: Jul. 27, 2017

(54) DEVELOPING DEVICE AND IMAGE FORMING APPARATUS

(71) Applicant: FUJI XEROX CO., LTD., Tokyo (JP)

(72) Inventors: Shunichiro SHISHIKURA, Kanagawa (JP); Ryo FUKUNO, Kanagawa (JP); Toshiaki SUZUKI, Kanagawa (JP); Hiroaki OKUMA, Kanagawa (JP); Yasutomo ISHII, Kanagawa (JP); Daisuke UCHIMITSU, Kanagawa (JP)

(73) Assignee: FUJI XEROX CO., LTD., Tokyo (JP)

(21) Appl. No.: 15/212,364

(22) Filed: Jul. 18, 2016

(30) Foreign Application Priority Data
Jan. 21, 2016 (JP) 2016-009734

(51) Int. Cl. G03G 15/08

(52) U.S. Cl. CPC G03G 15/0881

(57) ABSTRACT

A developing device includes a developer containing body having an opening and containing developer, a developer carrier that is disposed facing the opening of the developer containing body, and rotates while carrying the developer, and a seal member attached over the opening of the developer containing body to seal the gap between the developer containing body and the developer carrier. The seal member includes an upstream seal part that seals between the developer containing body, and a part of the developer carrier located upstream with respect to its rotational direction, a first side seal part that seals between the developer containing body, and one axial end side of the developer carrier, and a second side seal part that seals between the developer containing body, and the other axial end side of the developer carrier. The upstream seal part, and the first and second side seal parts are integrated together.

### CROSS-REFERENCE TO RELATED APPLICATIONS

This application is based on and claims priority under 35 USC 119 from Japanese Patent Application No. 2016-009734 filed Jan. 21, 2016.

### BACKGROUND

### Technical Field

The present invention relates to a developing device, and an image forming apparatus.

### SUMMARY

According to an aspect of the invention, there is provided a developing device including a developer containing body that has an opening, and contains a developer, a developer carrier that is attached at a location facing the opening of the developer containing body, and rotates while carrying the developer, and a seal member attached over the opening of the developer containing body to seal a gap between the developer containing body and the developer carrier, the seal member including an upstream seal part that seals between the developer containing body, and a part of the developer carrier located upstream with respect to a direction of rotation of the developer carrier, a first side seal part that seals between the developer containing body, and a part of the developer carrier located at one axial end side, and a second side seal part that seals between the developer containing body, and a part of the developer carrier located at another axial end side, the upstream seal part, the first side seal part, and the second side seal part being integrated together.

### BRIEF DESCRIPTION OF THE DRAWINGS

Exemplary embodiment of the present invention will be described in detail based on the following figures, wherein:

FIG. 1 illustrates a general configuration of an image forming apparatus according to the exemplary embodiment;

FIG. 2 is a front view of a photoconductor drum as seen from a developing device;

FIG. 3 is a front view of a developing device as seen from a photoconductor drum;

FIG. 4 is a cross-sectional view taken along IV-IV in FIG. 3;

FIG. 5 is a cross-sectional view taken along V-V in FIG. 3; and

FIGS. 6A and 6B each illustrate a configuration of a seal film.

### DETAILED DESCRIPTION

Hereinafter, an exemplary embodiment of the present invention will be described in detail with reference to the attached drawings.

### General Configuration of Image Forming Apparatus

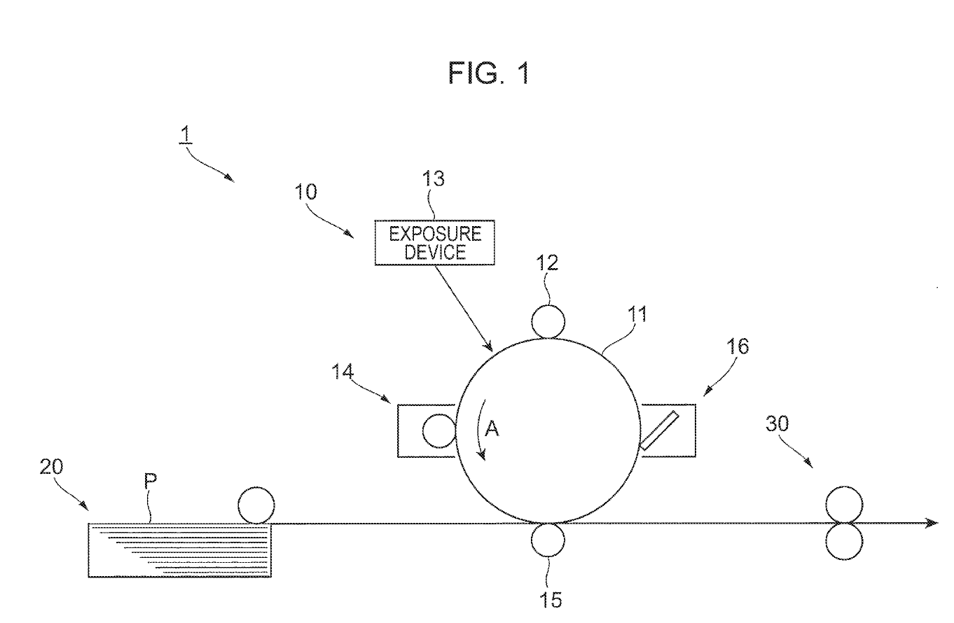

FIG. 1 illustrates a general configuration of an image forming apparatus 1 according to the exemplary embodiment.

The image forming apparatus 1 includes an image forming unit 10, a paper supply unit 20, and a fixing unit 30. The image forming unit 10 forms a monochrome (for example, black) toner image by an electrophotographic system. The paper supply unit 20 supplies a sheet P of paper toward the image forming unit 10. The fixing unit 30 fixes an image (toner image) formed on the sheet P by the image forming unit 10 onto the sheet P.

The image forming unit 10 has a photoconductor drum 11 that rotates in the direction of an arrow A illustrated in FIG. 1. The image forming unit 10 also includes the following components disposed around the photoconductor drum 11 in the direction of the arrow A: a charging roller 12, an exposure device 13, a developing device 14, a transfer roller 15, and a cleaning device 16.

The photoconductor drum 11, which is an example of an image carrier, is formed by a thin-walled cylindrical drum made of metal with a photosensitive layer (not illustrated) formed on its surface. The photosensitive layer is made of a material that is charged to negative polarity. The photoconductor drum 11 is grounded. Details of the photoconductor drum 11 will be given later.

The charging roller 12 is formed by, for example, a rubber roller having electrical conductivity. The charging roller 12, which is disposed in contact with the photoconductor drum 11, rotates following the rotation of the photoconductor drum 11. The charging roller 12 is applied with a charging bias for charging the photosensitive layer of the photoconductor drum 11 to negative potential.

The exposure device 13 uses a light source such as a laser or a light emitting diode (LED) to selectively write light onto the photoconductor drum 11 that has been charged to negative potential by the charging roller 12, thus forming an electrostatic latent image. The exposure device 13 according to the exemplary embodiment performs exposure by a so-called image-portion exposure system. In the image-portion exposure system, light is applied to an area (image portion) that will become a toner image (image), and light is not applied to an area (background portion) that will become the background.

In the exemplary embodiment, the charging roller 12 and the exposure device 13 function as an example of a latent image forming unit.

The developing device 14, which is an example of a developing unit, develops the electrostatic latent image formed on the surface of the photoconductor drum 11, by using a toner of a predetermined color (black in this case). The developing device 14 contains developer including a toner of a predetermined color (black in this case). The developing device 14 uses, as developer, a so-called two-component developer including a carrier that exhibits magnetic properties, and a toner that is colored in a predetermined color. The carrier of the developer has a positive charge polarity, and the toner has a negative charge polarity. Details of the developing device 14 will be given later.

The transfer roller 15 is formed by, for example, a rubber roller having electrical conductivity. The transfer roller 15, which is disposed in contact with the photoconductor drum 11, rotates following the rotation of the photoconductor drum 11. The transfer roller 15 is applied with a transfer bias having a polarity (positive in this case) opposite to the polarity of the charge on the toner.

The cleaning device 16 has, for example, a component such as a blade member disposed in contact with the photoconductor drum 11. The cleaning device 16 cleans off any substance (such as toner) that remains adhering on the photoconductor drum 11 after the transfer process and before the charging process.

The paper supply unit 20 has a container that contains sheets P, and a feed mechanism that feeds each sheet P. The paper supply unit 20 also has a transport mechanism (not illustrated) that transports the fed sheet P to the outside of the image forming apparatus, via a transfer part where the photoconductor drum 11 and the transfer roller 15 are located opposite each other, and the fixing unit 30.

Further, the fixing unit 30 has a pair of rotating bodies that rotates while in contact with each other. In the fixing unit 30, at least one of the two rotating bodies is heated, and the sheet P is passed through a fixing nip part defined between the two rotating bodies.

### Image Forming Operation

Now, an image forming operation performed by the image forming apparatus 1 illustrated in FIG. 1 will be described.

In the image forming unit 10, the photoconductor drum 11 that rotates in the direction of the arrow A is charged by a charge bias supplied to the charging roller 12 that contacts the photoconductor drum 11. Next, exposure using the exposure device 13 is started. As the charged photoconductor drum 11 rotates, an image portion on the photoconductor drum 11 is selectively exposed to light emitted from the exposure device 13. As a result, an electrostatic latent image including a background portion (non-exposed part) and an image portion (exposed part) is formed on the photosensitive layer made of an organic material and on which the charging and exposure processes have been performed.

Subsequently, as the photoconductor drum 11 rotates, the electrostatic latent image formed on the photoconductor drum 11 reaches a developing area located opposite the developing device 14. As the photoconductor drum 11 undergoes development by the developing device 14, a toner image corresponding to the electrostatic latent image is developed on the photoconductor drum 11 that has passed through the developing area.

As the photoconductor drum 11 rotates, the toner image thus developed on the photoconductor drum 11 moves toward a transfer position located opposite the transfer roller 15. Meanwhile, the sheet P picked up from the paper supply unit 20 is transported by a transport mechanism (not illustrated) to the transfer position in synchronism with the timing when the toner image on the photoconductor drum 11 reaches the transfer position.

Then, as the photoconductor drum 11 rotates, the toner image developed on the photoconductor drum 11 reaches the transfer position located opposite the transfer roller 15. At this time, a transfer bias supplied to the transfer roller 15 causes the toner image on the photoconductor drum 11 to be (electrostatically) transferred onto the sheet P passing through the transfer position. As the photoconductor drum 11 further rotates, any substance such as toner remaining on the photoconductor drum 11 after the transfer process reaches the area located opposite the cleaning device 16, and cleaned off.

Then, heat and pressure are applied to the sheet P with the transferred toner image as the sheet P passes through the fixing unit 30. The toner image is thus fixed onto the sheet P.

This completes an image forming operation for a single sheet of paper P.

### Configuration of Photoconductor Drum

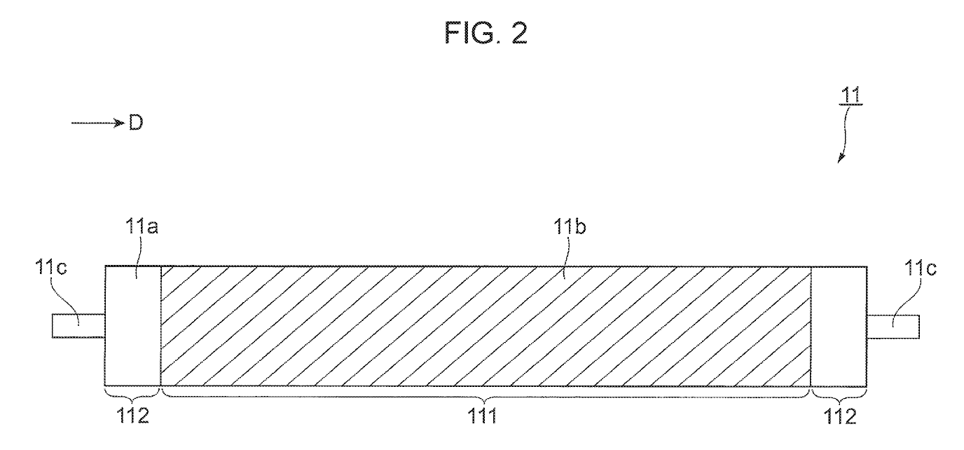

FIG. 2 is a front view of the photoconductor drum 11 as seen from the developing device 14.

The photoconductor drum 11 includes a cylindrical body 11a, a photosensitive layer 11b, and a rotating shaft 11c. The cylindrical body 11a is formed in a cylindrical shape, and extends in an axial direction D that runs from left to right in FIG. 2 (from the near side to the far side of FIG. 1). The photosensitive layer 11b is provided on the outer peripheral surface of the cylindrical body 11a. The rotating shaft 11c extends outward from both axial ends of the cylindrical body 11a, and is rotatably held onto the image forming apparatus 1. The cylindrical body 11a and the rotating shaft 11c are made of, for example, a metallic material. The photoconductor drum 11 is grounded via the rotating shaft 11c. The photosensitive layer 11b of the photoconductor drum 11 is formed in a central portion of the outer peripheral surface of the cylindrical body 11a excluding both end sides of the outer peripheral surface with respect to the axial direction D. As a result, the outer peripheral surface of the cylindrical body 11a is exposed to the outside at its both end sides with respect to the axial direction D. In the following description, an area on the photoconductor drum 11 where the photosensitive layer 11b is provided to allow formation of an image (toner image) will be referred to as image area 111, and an area on the photoconductor drum 11 where the photosensitive layer 11b is not provided, the cylindrical body 11a is exposed to the outside, and thus an image may not be formed will be referred to as non-image area 112.

### Configuration of Developing Device

Next, the developing device 14 according to the exemplary embodiment will be described.

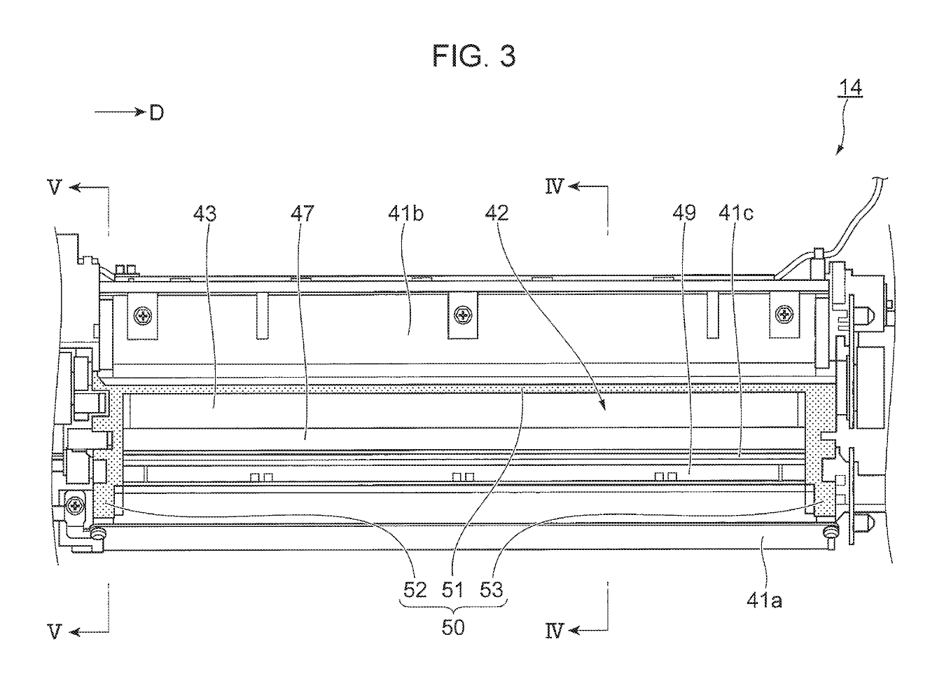

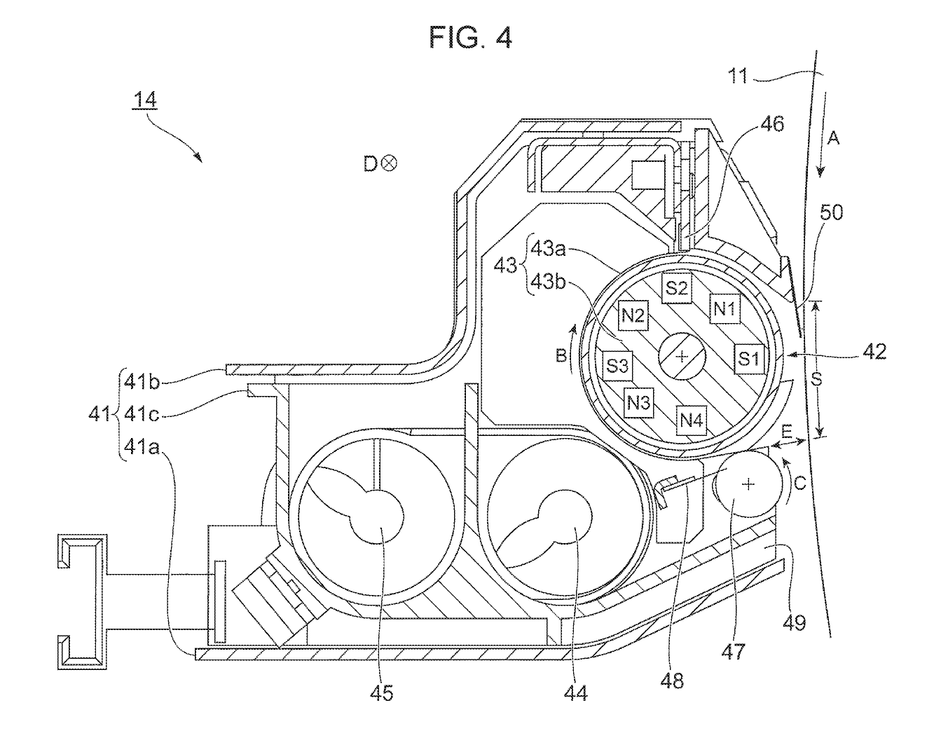

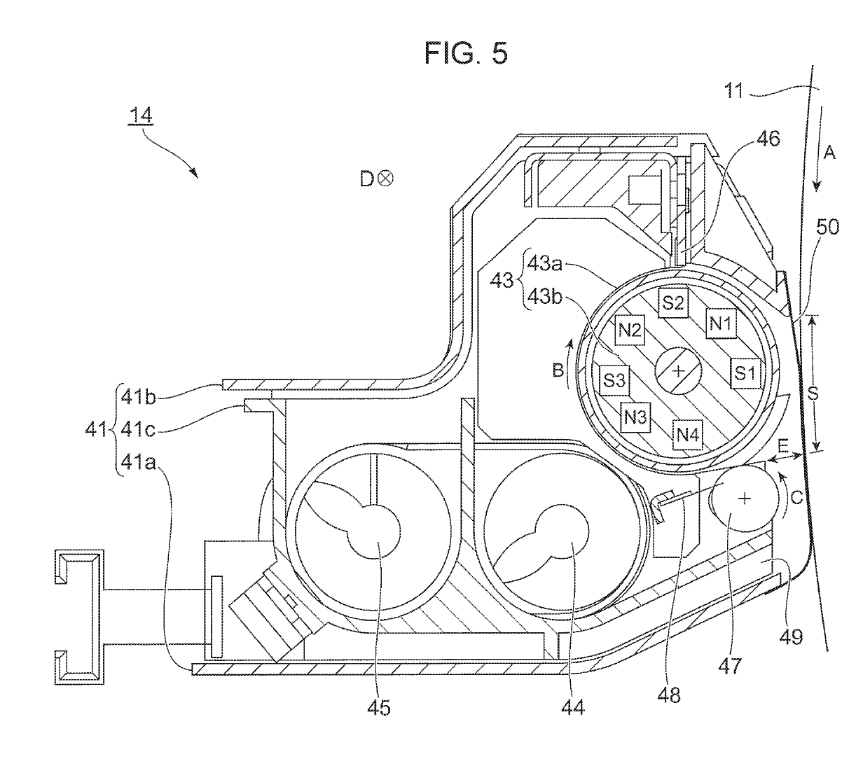

FIG. 3 is a front view of the developing device 14 as seen from the photoconductor drum 11. FIG. 4 is a cross-sectional view taken along IV-IV in FIG. 3. FIG. 5 is a cross-sectional view taken along V-V in FIG. 3. FIG. 4 is a cross-section taken at the position of the image area 111 (see FIG. 2) located in the central side of the photoconductor drum 11 with respect to the axial direction D. FIG. 5 is a cross-section taken at the position of the non-image area 112 (see FIG. 2) located at one end side of the photoconductor drum 11 with respect to the axial direction D.

The developing device 14 includes a developing housing 41, and a developing roller 43. The developing housing 41 has an opening area 42, which is an example of an opening, in a part of the developing housing 41 located opposite the photoconductor drum 11. The developing housing 41 contains developer. The developing roller 43 is disposed at a location facing the opening area 42 of the developing housing 41, and extends in the axial direction D. The developing housing 41, which is an example of a developer containing body, includes a lower housing 41a located at a relatively low position, an upper housing 41b located above the lower housing 41a, and an inner housing 41c located in a part of the developing housing 41 sandwiched between the lower housing 41a and the upper housing 41b. The developing roller 43 is disposed in the space defined by the upper housing 41b and the inner housing 41c.

The developing roller 43, which is an example of a developer carrier, includes a developing sleeve 43a and a magnet roller 43b. The developing sleeve 43a is disposed in a rotatable manner. The magnet roller 43b is disposed in a stationary manner inside the developing sleeve 43a, and has multiple magnetic poles arranged inside the magnet roller 43b. The developing sleeve 43a is driven to rotate in the direction of an arrow B. In a developing area S located opposite the photoconductor drum 11, the developing sleeve 43a rotates in the same direction as the photoconductor drum 11. The developing sleeve 43a is made of, for example, a metal such as SUS. A developing bias with the same polarity as the polarity of the charge on the toner is applied to the developing sleeve 43a. The configuration of the multiple magnetic poles formed in the magnet roller 43b will be described later.

The developing device 14 also includes a first screw 44 and a second screw 45. Each of the first screw 44 and the second screw 45 is disposed in the interior of the developing housing 41 at a position behind the developing roller 43, and extends in the axial direction D. The first screw 44 and the second screw 45 are disposed in the space defined by the upper housing 41b and the inner housing 41c. The first screw 44 and the second screw 45 are separated from each other by a partition wall provided in the inner housing 41c. The partition wall is not provided at both end sides with respect to the axial direction D (areas located outward of the area illustrated in FIG. 5).

The developing device 14 further includes a trimmer 46. The trimmer 46 is disposed opposite the developing roller 43 to regulate the thickness of a layer of developer formed on the developing roller 43. The trimmer 46 is disposed in the space defined by the upper housing 41b and the inner housing 41c. The trimmer 46 is attached to the upper housing 41b such that the trimmer 46 is located above the developing roller 43.

Furthermore, the developing device 14 includes a seal roller 47. The seal roller 47 is disposed at a location below the developing roller 43 and facing the opening area 42 of the developing housing 41, and extends in the axial direction D. The seal roller 47 is disposed in the space defined by the upper housing 41b and the inner housing 41c. The seal roller 47 has the function of recovering the toner scattering to the vicinity of the photoconductor drum 11, and the function of sealing the gap created between the opening area 42 and the developing roller 43. The seal roller 47 is driven to rotate in the direction of an arrow C. At a location opposite the photoconductor drum 11, the seal roller 47 rotates in a direction opposite to the photoconductor drum 11, and at a location opposite the developing sleeve 43a, the seal roller 47 rotates in the same direction as the developing sleeve 43a. The seal roller 47 is made of, for example, a metal such as SUS. A recovery bias with a polarity opposite to the polarity of the charge on the toner is applied to the seal roller 47.

The developing device 14 also includes a scraper 48. The scraper 48, which is disposed in contact with the seal roller 47, scrapes off foreign substances such as toner adhering on the seal roller 47. The scraper 48 is disposed in the space defined by the upper housing 41b and the inner housing 41c such that the scraper 48 comes into contact with the seal roller 47 in a direction counter to the direction of rotation of the seal roller 47.

The seal roller 47 according to the exemplary embodiment is disposed in a manner that allows the seal roller 47 to move in the direction of an arrow E toward or away from the photoconductor drum 11. When a photoconductor drum unit including components such as the photoconductor drum 11 and the developing device 14 is mounted to the image forming apparatus 1, and the developing device 14 is set at the position (image forming position) illustrated in FIG. 1, the seal roller 47 is pushed in toward the developing housing 41, thus keeping a constant distance between the photoconductor drum 11 and the seal roller 47.

Further, the developing device 14 includes a suction duct 49. The suction duct 49 is disposed at a location below the seal roller 47 and facing the opening area 42 of the developing housing 41, and extends in the axial direction D. The suction duct 49 is created by the space defined between the lower housing 41a and the inner housing 41c. The suction duct 49 is open at its side near the opening area 42. The suction duct 49 is connected to a fan (not illustrated). The suction duct 49 has the function of recovering the toner scattering to the vicinity of the photoconductor drum 11, together with the seal roller 47.

Furthermore, the developing device 14 includes a seal film 50 disposed at a location facing the opening area 42 of the developing housing 41. The seal film 50 has the function of sealing the gap created between the opening area 42 and the developing roller 43 (except for the area near the seal roller 47 located downstream with respect to the direction of rotation (direction of the arrow B) of the developing sleeve 43a). Details of the seal film 50 will be given later.

Now, the multiple magnetic poles provided in the magnet roller 43b constituting the developing roller 43 are described. The magnet roller 43b has seven magnetic poles, N1 to N4 (N-poles) and S1 to S3 (S-poles), along its outer peripheral surface. The magnetic pole N3 (pickup pole) has the function of attracting, onto the developing sleeve 43a, the developer agitated and transported by the first screw 44. The magnetic pole S2 (trimming pole) has the function of regulating a layer of developer attracted on the developing sleeve 43a to a predetermined thickness by means of the gap created between the magnetic pole S2 and the trimmer 46 disposed opposite the magnetic pole S2. The magnetic poles S3, N2, and N1 (transport poles) have the function of transporting, as the developing sleeve 43a rotates, the layer of developer attracted on the developing sleeve 43a after having its thickness regulated. Further, the magnetic pole S1 (development pole) has the function of transporting the developer attracted on the developing sleeve 43a and, by acting together with the magnetic pole N1, forming a brush of developer in the developing area S where the photoconductor drum 11 and the developing roller 43 are located opposite each other. Furthermore, the magnetic pole N4 (pickoff pole) has the function of generating a repulsive magnetic field together with the magnetic pole N3 adjacent to the magnetic pole N4, thus separating, from the developing sleeve 43a, the two-component developer attracted onto the developing sleeve 43a that has undergone the development process (passed through the developing area S).

### Configuration of Seal Film

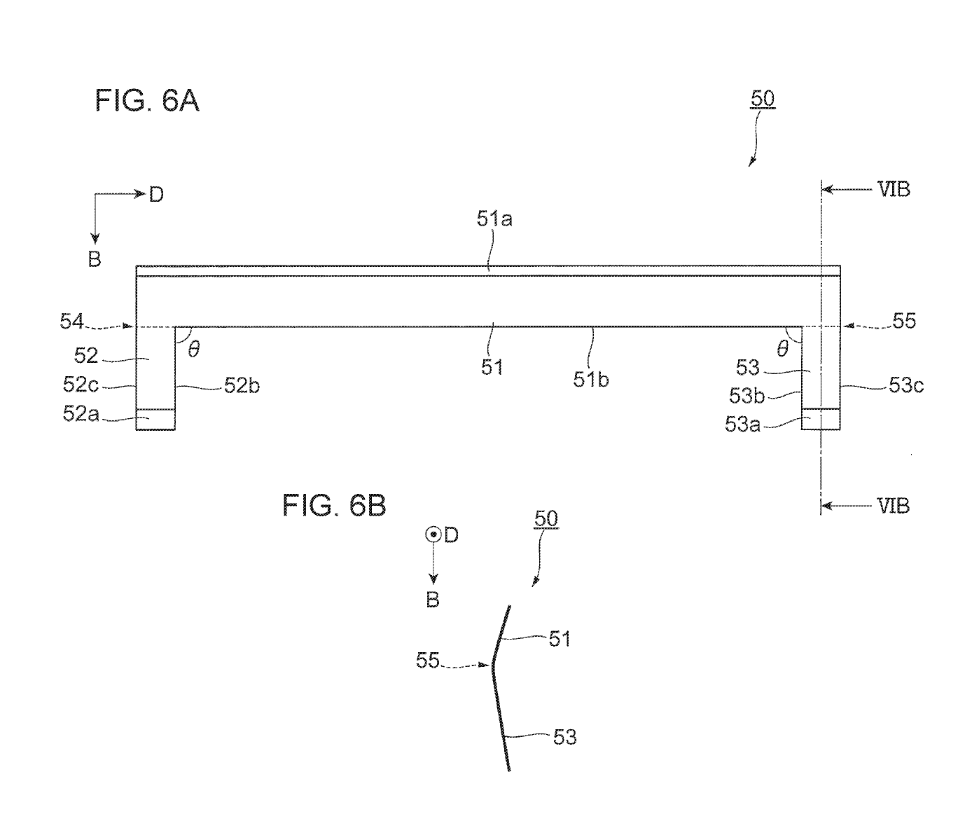

FIGS. 6A and 6B illustrate a configuration of the seal film 50. FIG. 6A is a front view of the seal film 50, and FIG. 6B is a cross-sectional view taken along VIB-VIB in FIG. 6A.

The seal film 50, which is an example of a seal member, includes an upper seal 51, a first side seal 52, and a second side seal 53. The upper seal 51 is an example of an upper seal part extending in the axial direction D. The first side seal 52 extends in a rotational direction B of the developing sleeve 43a from one end side (upstream side) of the upper seal 51 with respect to the axial direction D. The second side seal 53 extends in the rotational direction B of the developing sleeve 43a from the other end side (downstream side) of the upper seal 51 with respect to the axial direction D. As a result, in front view, the seal film 50 according to the exemplary embodiment has a “squared U” shape as a whole.

The seal film 50 has, at the boundary between the upper seal 51 and the first side seal 52, a first mountain-fold part 54 where the seal film 50 is folded to produce a mountain-shaped figure on the near side of FIG. 6A (the left side in FIG. 6B). The seal film 50 also has, at the boundary between the upper seal 51 and the second side seal 53, a second mountain-fold part 55 where the seal film 50 is folded to produce a mountain-shaped figure on the near side of FIG. 6A (the left side in FIG. 6B). The seal film 50 thus has a “V” shape as a whole in side view.

The seal film 50 is fabricated by stamping a PPT film with a thickness set to about 50 μm. As such, the seal film 50 has an integrated structure that is free from, for example, seams. The seal film 50 (the upper seal 51) has a length in the axial direction D that is greater than the length in the axial direction D of the opening area 42 provided in the developing housing 41. Further, the seal film 50 (the first side seal 52 and the second side seal 53) has a length in the rotational direction B that is greater than the length in the rotational direction B of the opening area 42 provided in the developing housing 41.

At the upper end side (upstream side with respect to the rotational direction B) of the upper seal 51 of the seal film 50, an upper holding part 51a for holding the seal film 50 onto the developing housing 41 is provided so as to extend in the axial direction D. At the downstream end side (downstream side with respect to the rotational direction B) of the first side seal 52 of the seal film 50, a first side holding part 52a for holding the seal film 50 onto the developing housing 41 is provided so as to extend in the axial direction D. Further, at the downstream end side (downstream side with respect to the rotational direction B) of the second side seal 53 of the seal film 50, a second side holding part 53a for holding the seal film 50 onto the developing housing 41 is provided so as to extend in the axial direction D. The upper holding part 51a, the first side holding part 52a, and the second side holding part 53a are each implemented by, for example, a double-faced tape or adhesive.

An upper-seal lower end 51b exists at the lower end portion of the upper seal 51. The upper-seal lower end 51b becomes a free end when the seal film 50 is mounted to the developing housing 41. A first-side-seal inner end 52b exists at the inside end portion of the first side seal 52. The first-side-seal inner end 52b becomes a free end when the seal film 50 is mounted to the developing housing 41. A first-side-seal outer end 52c exists at the outside end portion of the first side seal 52. The first-side-seal outer end 52c becomes a free end when the seal film 50 is mounted to the developing housing 41. A second-side-seal inner end 53b exists at the inside end portion of the second side seal 53. The second-side-seal inner end 53b becomes a free end when the seal film 50 is mounted to the developing housing 41. A second-side-seal outer end 53c exists at the outside end portion of the second side seal 53. The second-side-seal outer end 53c becomes a free end when the seal film 50 is mounted to the developing housing 41.

For the seal film 50, the angle θ formed by the upper seal 51 (the upper-seal lower end 51b) and the first side seal 52 (the first-side-seal inner end 52b), and the angle θ formed by the upper seal 51 (the upper-seal lower end 51b) and the second side seal 53 (the second-side-seal inner end 53b) are set to 90 degrees or to a value slightly less than 90 degrees.

### Positional Relationship between Developing Housing and Seal Film in Developing Device

Next, the positional relationship between the developing housing 41 and the seal film 50 in the developing device 14 will be described with reference to FIGS. 3 to 6B.

First, the upper holding part 51a of the upper seal 51 of the seal film 50 is attached to the upper housing 41b of the developing housing 41. The first side holding part 52a of the first side seal 52, and the second side holding part 53a of the second side seal 53 of the seal film 50 are each attached to the lower housing 41a of the developing housing 41.

With the seal film 50 mounted to the developing housing 41, each of the first side seal 52 and the second side seal 53 provided in the seal film 50 is in a slackened state (curved to protrude toward the photoconductor drum 11 located opposite the seal film 50). Further, with the seal film 50 mounted to the developing housing 41, each of the first mountain-fold part 54 and the second mountain-fold part 55 provided in the seal film 50 protrudes outward of the developing device 14, that is, toward the photoconductor drum 11 located opposite the seal film 50. Furthermore, with the seal film 50 mounted to the developing housing 41, the first-side-seal outer end 52c provided in the first side seal 52 of the seal film 50, and the second-side-seal outer end 53c provided in the second side seal 53 of the seal film 50 are each abutted against the inner wall of the developing housing 41 inside the opening area 42.

### Positional Relationship between Developing Roller and Seal Film in Developing Device

Next, the positional relationship between the developing roller 43 (the developing sleeve 43a) and the seal film 50 in the developing device 14 will be described with reference to FIGS. 2 to 6B.

With the seal film 50 mounted to the developing housing 41, at the upstream side of the developing area S, the upper-seal lower end 51b of the upper seal 51 in the seal film 50 is located opposite the outer peripheral surface of the developing roller 43 (the developing sleeve 43a). The brush of developer layer (so-called magnetic brush) formed on the developing sleeve 43a comes into contact with the inside of the upper-seal lower end 51b of the upper seal 51.

With the seal film 50 mounted to the developing housing 41, the first-side-seal inner end 52b of the first side seal 52 in the seal film 50 covers the outer peripheral surface at one end side (upstream side) of the developing roller 43 (the developing sleeve 43a) with respect to the axial direction D. Further, with the seal film 50 mounted to the developing housing 41, the second-side-seal inner end 53b of the second side seal 53 in the seal film 50 covers the outer peripheral surface at the other end side (downstream side) of the developing roller 43 (the developing sleeve 43a) with respect to the axial direction D.

### Positional Relationship between Photoconductor Drum and Seal Film in Developing Device

Now, the positional relationship between the photoconductor drum 11 and the seal film 50 in the developing device 14 will be described with reference to FIGS. 2 to 6B.

First, the upper seal 51 of the seal film 50 provided in the developing device 14 is disposed at a position opposite the image area 111 that is located in the central side of the photoconductor drum 11 with respect to the axial direction D. It is to be noted that the upper seal 51 does not contact the image area 111.

The first side seal 52 of the seal film 50 provided in the developing device 14 is disposed at a position opposite the non-image area 112 that is located at one end side (upstream side) of the photoconductor drum 11 with respect to the axial direction D. The first side seal 52 is in contact with the non-image area 112.

Further, the second side seal 53 of the seal film 50 provided in the developing device 14 is disposed at a position opposite the non-image area 112 that is located at the other end side (downstream side) of the photoconductor drum 11 with respect to the axial direction D. The second side seal 53 is in contact with the non-image area 112.

### Developing Operation

Nest, operation of the developing device 14 will be described.

The developer contained in the developing housing 41 is transported to circulate within the developing housing 41 while being agitated by the first screw 44 and the second screw 45. At this time, as the carrier and the toner that constitute the developer rub against each other, the toner and the carrier are charged, causing the toner to be electrostatically attracted onto the surface of the carrier. Then, when the developer is transported toward the developing roller 43 by the first screw 44, the carrier within the developer is sucked by the magnetic pole N3 provided in the magnet roller 43b of the developing roller 43, causing the toner adhering on the carrier to move toward the developing sleeve 43a together with the carrier. As a result, the developer forms a developer layer on the developing sleeve 43a.

Then, as the developing sleeve 43a rotates in the direction B, the developer layer formed on the developing sleeve 43a is moved by the magnetic pole N3, the magnetic pole S3, and the magnetic pole N2 together with the developing sleeve 43a. Then, as the developing sleeve 43a rotates in the direction B, the developer layer formed on the developing sleeve 43a passes through the area where the magnetic pole S2 and the trimmer 46 are located opposite each other. At this time, the developer layer on the developing sleeve 43a is regulated to a predetermined thickness. Subsequently, as the developing sleeve 43a rotates in the direction B, the developer layer on the developing sleeve 43a that has been regulated in thickness is moved by the magnetic pole N1 and the magnetic pole S1 together with the developing sleeve 43a until the developer layer reaches the opening area 42 located opposite the photoconductor drum 11. During this process, the developer layer formed on the developing sleeve 43a passes through the area located opposite the back side of the upper seal 51 of the seal film 50. At this time, the developer layer on the developing sleeve 43a comes into contact with the back side of the upper seal 51, thus scraping off the toner that has built up on the back of the upper seal 51. That is, the toner adhering on the back of the upper seal 51 is cleaned off with the magnetic brush formed by the developer layer on the developing sleeve 43a.

The developing sleeve 43a is applied with a developing bias. In the developing area S located in close proximity to the photoconductor drum 11, the developer layer on the developing sleeve 43a develops an electrostatic latent image (not illustrated) formed on the photoconductor drum 11 into a visible image. Then, the developer layer that has passed through the opening area 42 and finished the developing process is further transported on the developing sleeve 43a, and stripped off from the developing sleeve 43a by the repulsive magnetic field generated between the magnetic pole N4 and the magnetic pole N3. Then, the developer layer is agitated and transported by the first screw 44 and the second screw 45 again inside the developing housing 41, making the developer layer ready for the next developing process.

At the time when the electrostatic latent image on the photoconductor drum 11 is developed with the developer carried on the developing sleeve 43a, the toner constituting the developer sometimes scatters to the vicinity of the opening area 42, creating a toner cloud. If the toner thus creating the toner cloud adheres onto the photoconductor drum 11 in large quantities, this causes image smear.

Accordingly, in the developing device 14 according to the exemplary embodiment, the seal roller 47 is provided in an area prone to toner clouding, specifically, in an area located downstream with respect to the direction of rotation of the developing sleeve 43a, and a seal bias is supplied to the seal roller 47. As a result, the toner floating at the lower side of the opening area 42 is electrostatically attracted onto the seal roller 47. Then, as the seal roller 47 rotates, the toner adhering on the seal roller 47 is transported to the area located opposite the scraper 48, and scrapped off by the scraper 48. The toner scraped off by the scraper 48 is agitated and transported by the first screw 44 and the second screw 45 inside the developing housing 41, making the toner ready for the next developing process.

In the developing device 14 according to the exemplary embodiment, in addition to the seal roller 47, the suction duct 49 is also provided in an area located downstream with respect to the direction of rotation of the developing sleeve 43a and below the seal roller 47, and a fan (not illustrated) is used to suck toner through the suction duct 49. As a result, the toner floating at the lower side of the opening area 42 (below the seal roller 47) is sucked into the suction duct 49. The toner sucked into the suction duct 49 is then collected for recovery into a waste toner recovery unit.

Although the foregoing description of the exemplary embodiment is directed to the developing device 14 that uses, as a developer, a two-component developer including carrier and toner, this is not to be construed restrictively. The developing device 14 according to the exemplary embodiment may use a so-called mono-component developer.

In the exemplary embodiment, the developing roller 43 (the developing sleeve 43a) rotates in the direction of the arrow B, and thus the upper seal 51 of the seal film 50 is disposed at the upper side located upstream with respect to the direction of rotation of the developing roller 43. If the developing roller 43 is designed to rotate in a direction opposite to the direction of the arrow B, then the upper seal 51 of the seal film 50 is disposed at the lower side located downstream with respect to the direction of rotation of the developing roller 43.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a developer containing body that has an opening, and contains a developer;
a developer carrier that is attached at a location facing the opening of the developer containing body, and rotates while carrying the developer; and
a seal member attached over the opening of the developer containing body to seal a gap between the developer containing body and the developer carrier, the seal member including
an upstream seal part that seals between the developer containing body, and a part of the developer carrier located upstream with respect to a direction of rotation of the developer carrier,
a first side seal part that seals between the developer containing body, and a part of the developer carrier located at one axial end side, and
a second side seal part that seals between the developer containing body, and a part of the developer carrier located at another axial end side,
the upstream seal part, the first side seal part, and the second side seal part being integrated together.

2. The developing device according to claim 1,
wherein the first side seal part and the second side seal part protrude toward an image carrier located opposite the opening.

3. The developing device according to claim 2,
wherein the first side seal part and the second side seal part are folded into a mountain fold as viewed from the image carrier.

4. The developing device according to claim 1,
wherein the developer carried on the developer carrier comes into contact with the upstream seal part.

5. An image forming apparatus comprising:
an image carrier that rotates;
a latent image forming unit that forms an electrostatic latent image on the image carrier; and
a developing unit that develops the electrostatic latent image on the image carrier by using a developer,
wherein the developing unit includes
a developer containing body that has an opening, and contains the developer, the opening being located opposite the image carrier and extending in an axial direction of the image carrier,
a developer carrier that is attached at a location facing the opening of the developer containing body, and rotates while carrying the developer, and
a seal member that is attached over the opening of the developer containing body to seal a gap between the developer containing body and the developer carrier, the seal member including
an upstream seal part that seals between the developer containing body, and a part of the developer carrier located upstream with respect to a direction of rotation of the developer carrier,
a first side seal part that seals between the developer containing body, and a part of the developer carrier located at one axial end side, and
a second side seal part that seals between the developer containing body, and a part of the developer carrier located at another axial end side,
the upstream seal part, the first side seal part, and the second side seal part being integrated together.

6. The image forming apparatus according to claim 5,
wherein the image carrier has a non-image portion in which no electrostatic latent image is formed by the latent image forming unit, the non-image portion being located at each axial end side of the image carrier, and
wherein the first side seal part and the second side seal part of the seal member are in contact with the non-image portion.
